(19) United States
(12) Patent Application Publication
(10) Pub. No.: US 2014/0168951 A1
(43) Pub. Date: Jun. 19, 2014

(54) Utility Wristband for Dog Walking

(71) Applicant: David M. Briere, San Diego, CA (US)

(72) Inventor: David M. Briere, San Diego, CA (US)

(21) Appl. No.: 14/109,916

(22) Filed: Dec. 17, 2013

Related U.S. Application Data
(60) Provisional application No. 61/738,043, filed on Dec. 17, 2012.

(51) Int. Cl. F21V 33/00

(52) U.S. Cl. CPC F21V 33/0008
USPC 362/103

(57) ABSTRACT

A utility wristband configured for dog walking is provided having a wrist engageable band for an engagement to an as-used configuration, encircled around a user's arm adjacent a wrist. The band is configured with a flashlight, bag container for waste bags, and hidden pocket which is closeable for storage of valuables. A secondary means for illumination is configured for removable engagement to both the band and a collar of a dog, thereby allowing the secondary means of illumination give a visual location signal concerning the dog's location. A removable flashlight and removable leash housing can also be engaged to the band.

This application claims priority to U.S. Provisional Patent Application Ser. No. 61/738,043 filed on Dec. 17, 2012, and by this reference includes herein the entire specification and all drawings therefrom.

### BACKGROUND OF THE INVENTION

1. Field of the Invention

The present invention relates generally to wristbands. More particularly, the invention relates to a multi-purpose utility wristband device especially well suited for employment while walking a leashed dog, providing a means for hand-free carrying, storage, and deployment of many of the related accessories often needed during such outings.

In a particularly preferred mode the device is adapted for engagement to a user's wrist and includes one or any suitable combination of a group of components including a light source housed within the wristband, a removably engageable light beacon adapted for affixing to the dog's collar for nighttime identification and tracking and for re-attachment to the wristband, a waste bag dispenser for waste collection and disposal, a zippered storage compartment, and means for engagement of additional accessories (i.e. a treat pouch, a travel-size water bowl, an obedience clicker, etc). The hands-free utility device provides an ideal training aid by substantially freeing the user's hands and attention as needed for obedience training.

2. Prior Art

Dog owners are typically encouraged to walk their dogs frequently as this generally constitutes part of the daily exercise required to keep a dog healthy and happy. Currently, leash laws have been passed in many cities which require owners to leash their dogs when in public areas in order to reduce the occurrence of the dogs frightening or biting people or other animals, defecating and urinating in inappropriate places, endangering traffic, digging up lawns, getting lost, and getting away from owners. Further, many laws require owners to clean up their pet's waste, as waste left on a sidewalk or lawn can pose health hazards for humans. As such, along with a leash, many dog owners will carry a plurality of waste collection bags, which can be used to pick up pet waste and properly dispose of it in a waste bin.

Many dog owners may also provide some type of obedience training so that their dog will reliably respond to commands both on and off a leash. Obedience training can come in many forms, from formal classes, to simple device which can be employed to simple commands. One such device is called a clicker, which is a small hand-held device that makes a distinct sound to indicate a desired behavior. This method is often preferred as the device can be carried while walking a dog and does not require the user to physically correct the dog, such as with the employment of pinch collars, shock collars, and the like.

It is more than clear that dog ownership requires a great amount of responsibility. Walking and caring for a dog is at times very challenging. Dog walking requires a great deal of the users attention, not only to the dogs behavior but also to their surroundings. These challenges are multiplied with large or untrained dogs, which can be quite hard to control on a leash. Walking at night compounds these issues due to lack of visibility and the user being unaware of dangers which may lie ahead. Therefor users often also carry a flashlight which can be critical to the users, and dogs, safety. One skilled in the art can clearly see that a dog owner's hands are quite literally full when juggling the leash, waste disposal bags, flashlights, obedience training devices, and their own personal items.

Prior art has failed to address this plurality of concurrent needs for a dog owner in any compact arm-engageable component. As a result, there is a continuing unmet need for a device which combines the utility of holding, dispensing, and tethering of the dog and many items used while walking a dog. Such a device should be providable to the user employable substantially hands-free, to allow the user to maintain their visual and hand sense attention on their dog and surroundings, and not on the carrying and storage of many of the associated items.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art and achieves the above noted goals through the provision of a wristband engageable device which combines the utility of many dog walking items including, but not limited to, a light source, a waste bag dispenser for waste collection and disposal, a zippered storage compartment, and means for engagement of additional accessories (i.e. a treat pouch, a travel-size water bowl, an obedience clicker, etc). The utility wristband device provides means for hands-free carrying, storage, and deployment of the many items associated with dog waling, giving the user more freedom and control during walks. The hands-free utility of the device makes it an ideal training aid by freeing the user's hands and attention for obedience training.

In accordance with a first preferred mode, the wristband device comprises a wrist worn band which is adapted for removable engagement to the wrist of a user. The band can be formed of conventional materials, such as fabric, webbing, or leather, however can be formed from any suitable material known in the art. Means for removable engagement can be provided by removable fasteners, such as hook and loop fabric, snap fits, buckles, or any other known fasteners suitable for the intended purpose.

The band preferably employs an operatively engaged light source means powered by replaceable or rechargeable power means, and in at least one preferred mode, a removably engageable light beacon which can be affixed to the dog's collar for nighttime identification and tracking if desired by the user. The beacon may also employ replaceable batteries, or may have a power source which is rechargeable in an engagement with a docking portion of the device, described in more detail later.

The utility wristband device also employs a waste bag dispenser means for pet waste collection and disposal. In at least one preferred mode, the dispenser means comprises a container which is engaged to, or formed integrally with, the band and is configured to store and dispense conventional rolls of waste bags.

The band of the device is preferably also configured with a pocket formed on at least one surface of the band. The pocket preferably includes at least one openable aperture, employing means for closing the aperture. This may be provided by a zipper, hook and loop fabric, or any other suitable means. In all preferred modes, the pocket provides the user with a storage compartment for a key, money, or other personal items.

Means for engagement of additional accessories can be provided by one or a plurality of reinforced rings, clips, or loops engaged to the band, which provides the user with the option of customizing the device. A pin and keyhole attachment may also be employed. The ring or loop may include a spring loaded gate, similar to carabiner, which will allow the user to engage additional accessories such as a treat pouch, a travel-size water bowl, an obedience clicker, or the like. A retractable tether may also be engaged using a pin and engagement aperture or clip and band engagement. The retractable tether would allow the device to take over from the user if their hand tires or be used in replacement of a hand engaged leash.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a perspective view of a particularly preferred mode of the utility wristband device showing various components.

FIG. 1a shows a side view of a preferred mode of a removably engageable light beacon which is engageable using a belt clip or projecting member configured to engage an aperture in the wristband.

FIG. 2 shows a top view of the device of FIG. 1.

FIG. 2a depicts a removably engageable retractable tether which may be engaged to the device.

FIG. 3 is a graphical depiction of the device engaged to a user wrist and showing the flashlight component illuminating the area toward the user's feet while the leash angles toward the dog.

### DETAILED DESCRIPTION OF THE PREFERRED

### Embodiments of the Invention

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

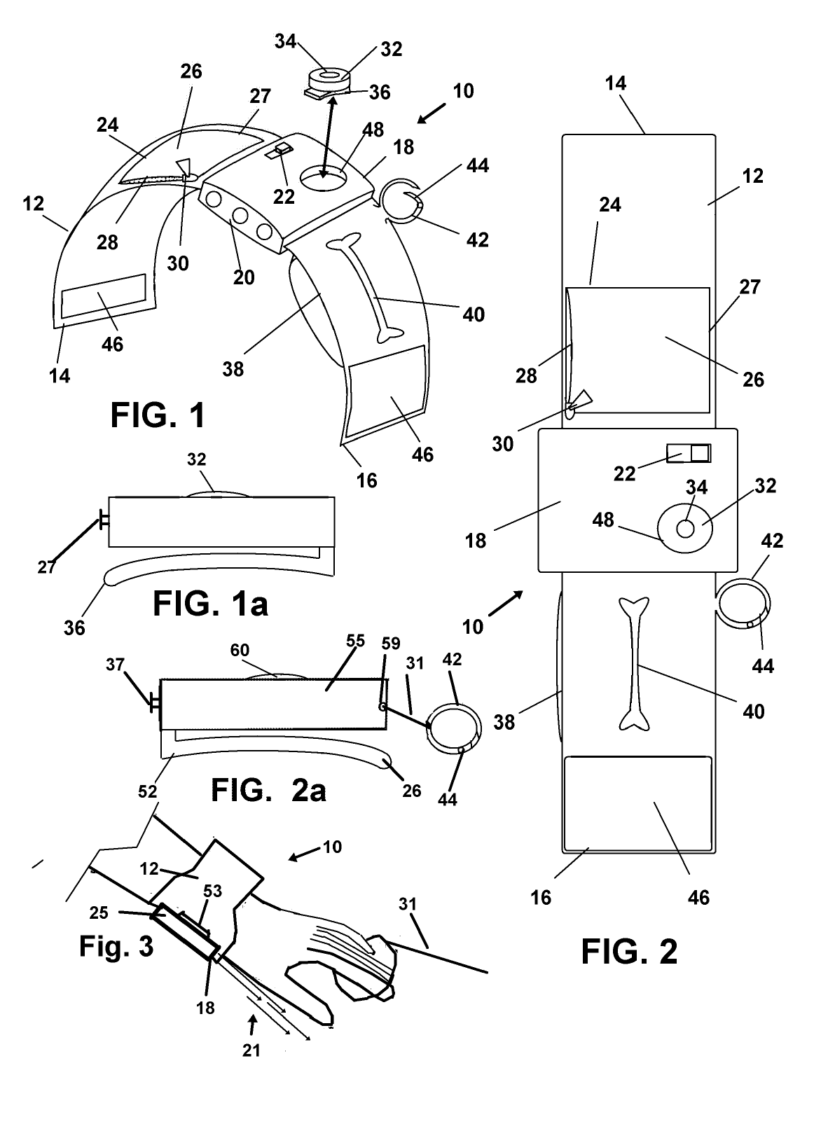

Now referring to drawings in FIGS. 1-3, wherein similar components are identified by like reference numerals, there is seen in FIG. 1 and FIG. 2 views of a particularly preferred mode of the utility wristband device 10. The device 10 is especially well suited as a utility wristband for dog walking. The device 10 provides a means for hands-free carrying, storage, and deployment of many of the items associated with dog walking, giving the user more freedom and control during walks. The hands-free utility of the device 10 makes it an ideal training aid.

In accordance with one preferred mode, the wristband device 10 comprises a wrist worn band 12 which is adapted for removable engagement to the wrist of a user. The band 12 may be formed of conventional materials, such as fabric, webbing, or leather, however can be formed from any suitable material known in the art. For example, the band 12 can be formed from material similarly used for watch bands.

Means for removable engagement of the band 12 ends to engage it to the wrist as in FIG. 3, can be provided by removable fasteners which allows for an overlapping engagement of the distal ends 14, 16 of the band 12 over a users wrist. Examples of removable fasteners which are suitable with the device 10 include, hook and loop fabric 46 as currently shown, snap fits, buckles, or any other known fastener suitable for the intended purpose. By engaging portions of hook and loop fabric 46 at or near the distal ends 14, 16 of the band 12, this allows the user to secure the band 12 in an overlapped engagement of the distal ends 14, 16 over their wrist as shown in FIG. 3. However other means for engagement may be employed and are anticipated.

A first utility of the device 10 is provided by the employment of an operatively means for illumination such as a flashlight 18 which may be battery powered or may include a rechargeable battery pack (not shown). The means for illumination such as the flashlight 18 includes one or a plurality of lights 20 such as light emitting diodes (LED) or other suitable light source. A powering switch 22 may be provided such that the user can turn the lights 20 off when not in use to conserve power.

Additionally, as shown in FIG. 3, the means for illumination such as a flashlight 18 may be engaged within an elastic tube or similar housing 25 which is engaged or removably engaged to the band 12 at a position to place it adjacent to the rear of the user's thumb, and when engaged, having its axis aligned with the arm axis. This provides the illumination 21 along a line which converges with the walking surface directly in front of the user, when holding the leash 31 in the as-used mode of FIG. 3. Thus the dog may be pulling on the leash normally, and the flashlight 18 will illuminate the ground in front of walking user.

Additionally and preferably included in the device 10 is a removably engageable light beacon 32 which can be disengaged from the device 10. So disengaged it is configured for a secure engagement to the dog's collar for nighttime visual location identification and tracking if desired by the user. The beacon 32 may employ replaceable batteries or may have a power source which is rechargeable in its engagement with the device 10. For example the light source means 18 may include a docking portion 48 which engages the beacon 32 for charging, through engaged electrical connection, or other suitable means.

The beacon 32 includes at least one light emitting source 34, such as an LED or other suitable means, and preferably a clip 36 which provides a means for engagement of the beacon 32 to a dogs collar. A blow up of the removably beacon is shown in FIG. 1a. However, it is noted that other means for engagement of the beacon 32 to both the band 12 and a planar dog collar, may be employed and are anticipated within the scope and intent of this invention.

At night, the two light sources allow for greater visibility and safer walking conditions. With a light source bright enough to illuminate his or her path, the user can now identify obstacles or dangers, as well as locate his or her dog's waste. The means for illumination shown as flashlight 18, is shown projecting from the hand-side of the device in FIG. 1, when in the as-used position of FIG. 3. This flashlight 18 or similar means for illumination, is hands-free when engaged to the device 10, and offers the user two hands to gain more control over his or her dog, and allows the user to focus more on the walk and the environment. The flashlight 18 or other means for illumination, also allows others (motorists, pedestrians) to better see the user. As noted, the removably engageable beacon 32 can be attached to the dog's existing collar, allowing for easier identification and tracking, on or off leash.

The utility wristband device 10 also employs waste bag dispenser means for pet waste collection and disposal. In at least one preferred mode, the dispenser means comprises a container 38 compartment, which is engaged to, or formed integrally with the band 12 and is configured to store and dispense conventional rolls of waste bags. At least one aperture 40 communicating with the interior of the container 38 formed integral to the band, allows the user to both refill the container 38 with waste bags, as well as individually dispense bags as needed for sanitary clean up of pet waste.

As such, this means for bag dispensing, is another hands-free utility that ensures the user maximum control during the walk. The bag dispenser encourages waste collection, by providing a repository for clean and new waste collection bags. For ease of manufacture, the container 38 and aperture 40 can be adapted to engage and dispense existing waste bag rolls which are conventionally known in the art. Such a removably engageable container 38 can resemble the illumination means of FIG. 1a, and have the aperture at numeral 32 in FIG. 1a. Engagement to the device 10 can be by using the slide on clip 36, or a projecting pin 37 adapted to securely engage with a receiving aperture in on the device 10.

The band 12 of the device 10 is preferably also configured with at least one pocket 24 formed on or within, at least one band surface of the band 12. The pocket 24 can be formed by engaging a pocket sidewall 26 onto the surface of the band 12 or in between two opposing surfaces forming the band 12. The sidewall 26 can be sewn or otherwise engaged to the band 12 along the peripheral edges 27 however leaving at least one edge disengaged to define at least one openable aperture 28. Means for closure of the openable aperture can be provided by a zipper 30, or other means for closure such as hook and loop fabric or snaps or buttons, and can be employed as a means for closing the aperture 28 and securing any items which are placed within the interior of the pocket. In all preferred modes, the pocket 24 provides the user with closeable storage compartment for a key, money, or other personal items and is particularly preferred.

Means for engagement of additional accessories can be provided by one or a plurality of reinforced rings 42 or loops engaged to the band 12, which provides the user with the option of customizing the device 10. The ring 42 may include a spring loaded gate 44, similar to a carabiner, which will allow the user to engage additional accessories such as a treat pouch, a travel-size water bowl, an obedience clicker (not shown), or the like. However, it is noted that other means for engagement of additional accessories which are recognized by those skilled in the art may be employed, and are considered part of this disclosure.

FIG. 2a, depicts a removably engageable retractable leash 31 having a ring 32 at the distal end or other clip. This allows attachment to a dog collar as well as maintaining the distal end of the leash 31 outside the housing 55 containing the biased roller for retracting and dispensing more or less leash 31. Such conventional retractable mechanisms are well known and not shown. Key to employment of this retractable leash component is a secure mounting to the device 10. Thus a clip 36 with its open end adjacent the leash 31 exit aperture 59 is preferred since force of the leash 31 will be imparted to the band 12 by the rear end 57 of the clip 36 which terminates in an endwall. A release 60 is shown on a top surface to allow release or rewinding of the leash 31. Also, a projecting pin 37 adapted to securely engage with a receiving aperture in on the device 10 or one of its components may also be sued to removably engage the retractable leash 31 to the device 10.

FIG. 3 is a graphical depiction of the device 10 engaged to a user wrist in the as-used position and showing a directed means for illumination such as a flashlight 18 component engaged in a preferred mode, directionally positioned on the band 12 to illuminate the area toward the user's feet while the leash 31 angles toward the dog and tends to pull the hand and arm slightly above where the hand would be at the user's side. This positioning is especially important as the user can see where they are about to walk irrespective of the dog's position.

As shown, the flashlight 18 can be held by a fabric or plastic or other housing 25 adapted to frictionally engage with the exterior of a flashlight 18. The housing 25 may best be engaged to the band 12 by hook and loop fabric 53 with half of the fabric pair on each component. This allows the user to remove and re-engage the housing 25 and illuminated flashlight 18 when they get their hand positioned normal during a walk, to direct the illumination 21 on the walking surface ahead of them to aid walking. It has been found that most users keep their hand, tensioned by the leash 31 from the moving dog, in a substantially similar position during each walk. So once the illumination 21 pattern is adjusted by attaching the housing 25, it will normally work for subsequent walks.

At night and during the day, hands-free carrying, storage, and deployment of many dog walking related items, allows for more control over our leashes and dogs, in addition to providing the tools necessary from cleaning up after them. The hands-free functions of the utility wristband device 10 offer the user maximum control over his or her dog on walks. The hands-free light source in the wristband is critical for both user safety and responsible waste clean up on dog walks. The light source allows for greater visibility on night walks and provides a means to locate waste in the dark. The detachable beacon light can be attached to any pet collar, allowing for easier identification and tracking of our dogs. The unique bag dispenser frees up the hands of the user, providing him or her with more control and freedom on walks. The utility wristband's zippered pocket provides storage for small items. The reinforced ring allows the user to customize their utility wristband with detachable accessories.

This invention has other applications, potentially, and one skilled in the art could discover these. The explication of the features of this invention does not limit the claims of this application; other applications developed by those skilled in the art will be included in this invention.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. A utility wristband configured for dog walking, comprising:
a wrist engageable band having a first end, a second end, and a middle portion therebetween;
means for removable engagement of said first end to said second end to form said wrist engageable band to an as-used configuration, encircled around a user's arm adjacent a wrist; and
first means for illumination engaged with said band in between said first and second ends;
said first means for illumination projecting illuminating light in a direction toward a hand of said user with said wrist engageable band in said as-used position on said user's arm;
a secondary means for illumination which is configured for removable engagement with a first mount which is engaged with said band;
said secondary means for illumination additionally configured for a removable engagement with a leash of a dog; and
whereby said user with said band in said as-used position my project said illuminating light toward a walking surface on which they are walking, and remove said secondary means for illumination from said first mount, and engage it to said leash, to provide a visual locator for said dog when walking in a dark area.

2. The utility wristband of claim 1, additionally comprising:
said first means for illumination being a flashlight;
a housing axially engageable with said flashlight;
hook or loop fabric attached to said housing;
the other of hook or loop fabric from that attached to said housing, attached to said band;
said housing engageable to said band, angles varying from aligned with an axis of said user's arm, to angled to said axis of said user's arm, through mating of said hook and loop fabric to position said housing at angles; and
projected illumination from said flashlight being adjustable for illumination of said walking surface, by said mating of said hook and loop fabric to obtain a desired angled engagement of said hosing.

3. The utility wristband of claim 1, additionally comprising:
said first means for illumination being a flashlight having a housing and having a biased clip extending therefrom to a distal end defining an opening to a slot; and
said housing engageable to said band by a sliding of said band into said slot.

4. The utility wristband of claim 2, additionally comprising:
said first means for illumination being a flashlight having a housing and having a biased clip extending therefrom to a distal end defining an opening to a slot; and
said housing engageable to said band by a sliding of said band into said slot.

5. The utility wristband of claim 1, additionally comprising:
a first pocket formed upon an exterior surface of said band or in between a pair of surfaces forming said band;
an aperture communicating with an interior cavity of said first pocket;
an openable closure providing means for closure of said aperture; and
whereby said interior cavity provides hidden storage for identification or vehicle keys and other valuable objects sided to fit in said interior cavity.

6. The utility wristband of claim 2, additionally comprising:
a first pocket formed upon an exterior surface of said band or in between a pair of surfaces forming said band;
an aperture communicating with an interior cavity of said first pocket;
an openable closure providing means for closure of said aperture; and
whereby said interior cavity provides hidden storage for identification or vehicle keys and other valuable objects sided to fit in said interior cavity.

7. The utility wristband of claim 3, additionally comprising:
a first pocket formed upon an exterior surface of said band or in between a pair of surfaces forming said band;
an aperture communicating with an interior cavity of said first pocket;
an openable closure providing means for closure of said aperture; and
whereby said interior cavity provides hidden storage for identification or vehicle keys and other valuable objects sided to fit in said interior cavity.

8. The utility wristband of claim 4, additionally comprising:
a first pocket formed upon an exterior surface of said band or in between a pair of surfaces forming said band;
an aperture communicating with an interior cavity of said first pocket;
an openable closure providing means for closure of said aperture; and
whereby said interior cavity provides hidden storage for identification or vehicle keys and other valuable objects sided to fit in said interior cavity.

9. The utility wristband of claim 7, additionally comprising:
a bag container engaged with said band, said bag container having a cavity sized for storage of a plurality of plastic bags sized for capture of dog excrement; and
an aperture communicating into said cavity and providing a means for dispensing bags therethrough, whereby a user may have a supply of plastic bags on his person when said band is in said as-used position.

10. The utility wristband of claim 8, additionally comprising:
a bag container engaged with said band, said bag container having a cavity sized for storage of a plurality of plastic bags sized for capture of dog excrement; and
an aperture communicating into said cavity and providing a means for dispensing bags therethrough, whereby a user may have a supply of plastic bags on his person when said band is in said as-used position.

11. The utility wristband of claim 1, additionally comprising:
a retractable leash engaged with a leash housing having an interior compartment for storage of a retracted said leash;
removable means for engagement of said leash housing to said band whereby said user may engage said leash to said band and engage a distal end thereof to a dog collar.

12. The utility wristband of claim 7, additionally comprising:
a retractable leash engaged at a proximal end with a leash housing having an interior compartment for storage of a retracted said leash;
removable means for engagement of said leash housing to said band whereby said user may engage said leash to said band and engage a distal end thereof to a dog collar.

13. The utility wristband of claim 8, additionally comprising:
a retractable leash engaged at a proximal end with a leash housing having an interior compartment for storage of a retracted said leash;
removable means for engagement of said leash housing to said band whereby said user may engage said leash to said band and engage a distal end thereof to a dog collar.

14. The utility wristband of claim 9, additionally comprising:
a retractable leash engaged at a proximal end with a leash housing having an interior compartment for storage of a retracted said leash;
removable means for engagement of said leash housing to said band whereby said user may engage said leash to said band and engage a distal end thereof to a dog collar.

15. The utility wristband of claim 10, additionally comprising:
a retractable leash engaged at a proximal end with a leash housing having an interior compartment for storage of a retracted said leash;
removable means for engagement of said leash housing to said band whereby said user may engage said leash to said band and engage a distal end thereof to a dog collar.
